(19) United States
(12) Patent Application Publication
(10) Pub. No.: US 2013/0068007 A1
(43) Pub. Date: Mar. 21, 2013

(54) Compact Surface Well Testing System and Method

(71) Applicants: Daniel Carelli, Macae (BR); Carlos Machado, Macae (BR); Eduardo Valdez, Macae (BR)

(72) Inventors: Daniel Carelli, Macae (BR); Carlos Machado, Macae (BR); Eduardo Valdez, Macae (BR)

(21) Appl. No.: 13/489,433

(22) Filed: Jun. 5, 2012

Related U.S. Application Data
(60) Provisional application No. 61/535,362, filed on Sep. 16, 2011.

(51) Int. Cl. E21B 47/10; B23P 11/00

(52) U.S. Cl. 73/152.29; 29/525.08

(57) ABSTRACT

A well testing system and method are provided. The well testing system includes a separator-exchanger module that may include a modular frame, a separator and/or a modular steam-heat exchanger. A surge tank module can include a surge tank, frames, and two surge tanks. A manifold model can include a compact manifold. The various modules of the well testing system can be interconnected using various guiding, stopping, and/or fixing clamps.

### CROSS-REFERENCE TO RELATED APPLICATIONS

This application claims the benefit of a related U.S. Provisional Application No. 61/535,362 filed Sep. 16, 2011, the disclosure of which is incorporated by reference herein in its entirety

### FIELD OF THE INVENTION

The invention relates to well testing systems, and methods therefor.

### BACKGROUND

Surface well testing provides information about reservoir extent, productivity, fluid properties, composition, flow, pressure, temperature, and others. The main objectives of surface well testing are to measure the volumetric flow-rate of individual phases, obtain samples and determine characteristics of the main fluids (e.g., water, oil, and gas), and solids. The surface testing equipment must perform a wide range of functions, including: control pressure and flow rates at the surface and shut in the well; accurately meter the fluids and collect surface fluid samples; and separate the resulting effluent into three fluids: oil, gas, water, and solids.

Current well testing systems suffer from various problems, including: limited space on drilling rigs, large equipment volume, and the amount of rig up time required by personnel. In addition, personnel involved in assembling and/or disassembling current well testing systems are exposed to risky activities, such as carrying heavy equipment, stepping and handling equipment in crowed and restricted areas, moving large equipment and piping, the difficulty assembling such equipment during significant dynamic motion of an offshore drilling rig (e.g., caused by waves or wind), and the difficulty in transferring installed systems from one rig to another. Moreover, after a well testing system is assembled, the operation of the conventional systems present personnel further difficulties and hazards, such as accessing walkways, stairs, and handrails to operate equipment (e.g., walkways, stairs and handrails), moving between equipment in non-standardized layouts.

Accordingly, there exists a need in the art to overcome the deficiencies and limitations described hereinabove.

### BRIEF SUMMARY

In embodiments of the present disclosure, a well testing system comprises a number of modules. A first module includes a separator frame configured to receive a separator and/or a steam-heat exchanger. A second module includes a fluid storage i.e. surge tank frame including a surge tank front frame, wherein the surge tank frame is configured to receive at least two surge tanks. A third module includes a compact flow control i.e. manifold comprising oil, gas and water manifolds; oil and water transfer pumps. At least one of the separator frame, the separator, the steam-heat exchanger, the surge tank frame, and the surge tanks interconnects with another apparatus (i.e., element) of the group through one or more clamps.

In other embodiments of the present disclosure, a method comprises constructing a well testing system. The method includes placing a separator frame on a deck. The method further includes placing a first guiding, stopping and/or fixing clamp on the separator frame. The method further includes placing a separator on the separator frame using the first guiding, stopping and/or fixing clamp. The method further includes placing a modular surge tank frame and a modular surge tank front frame, and assembling the modular surge tank frame and the modular surge tank front frame to obtain a surge tank frame. Further, the method includes placing a second guiding, stopping and/or fixing clamps on the surge tank frame and placing two surge tanks on the surge tank frame using the third guiding, stopping and/or fixing clamps. Also, the method includes placing a compact manifold on the deck. The method further includes interconnecting the separator frame with the surge tank frame and the compact manifold. This method also includes the connection of all modules as a unique compact arrangement or as a distributed arrangement in order to adapt to different deck spaces in the offshore units.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Embodiments of well testing system are described with reference to the following figures. The same numbers are used throughout the figures to reference like features and components.

FIG. 1 illustrates a well testing system in accordance with one or more embodiments disclosed herein;

FIG. 2 illustrates a modular separator frame in accordance with one or more embodiments disclosed herein;

FIG. 3 illustrates a separator and a steam-heat exchanger assembly in accordance with one or more embodiments disclosed herein;

FIG. 4A-4G illustrate guiding and fixing clamps in accordance with embodiments disclosed herein;

FIG. 5 illustrates a modular surge tank frame in accordance with embodiments disclosed herein;

FIG. 6 illustrates a surge tank front frame in accordance with one or more embodiments disclosed herein;

FIG. 7 depicts a surge tank clamp in accordance with one or more embodiments disclosed herein;

FIG. 8 depicts a surge tank module in accordance with one or more embodiments disclosed herein;

FIG. 9 depicts a manifold module in accordance with one or more embodiments disclosed herein;

FIG. 10 depicts a modular separator frame fixed on deck in accordance with one or more embodiments disclosed herein;

FIG. 11 depicts a modular separator frame with clamps in accordance with one or more embodiments disclosed herein;

FIG. 12 illustrates a modular separator frame with the separator in accordance with one or more embodiments disclosed herein;

FIGS. 13-15 illustrate guiding and fixing clamps for the modular separator frame in accordance with one or more embodiments disclosed herein;

FIGS. 16 and 17 illustrate a modular separator frame with the separator in accordance with one or more embodiments disclosed herein;

FIG. 18 depicts a modular separator frame with the separator and the steam-heat exchanger in accordance with one or more embodiments disclosed herein;

FIG. 19 depicts intermediate spools with the separator and steam-heat exchanger module in accordance with one or more embodiments disclosed herein;

FIG. 20 depicts the separator and steam-heat exchanger module with the compact manifold module in accordance with one or more embodiments disclosed herein;

FIGS. 21 and 22 depict a compact manifold module in accordance with one or more embodiments disclosed herein;

FIG. 23 depicts a detail of the attachment of the modular surge tank frame and the modular surge tank front in accordance with one or more embodiments disclosed herein;

FIG. 24 depicts a modular surge tank frame and a modular surge tank front frame in accordance with one or more embodiments disclosed herein;

FIG. 25 depicts a surge tank frame and surge tanks in accordance with one or more embodiments disclosed herein; and

FIGS. 26-28 depict surge tank frame and surge tank placement in accordance with one or more embodiments disclosed herein.

### DETAILED DESCRIPTION

Specific embodiments of the present disclosure will now be described in detail with reference to the accompanying drawings. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Language used in the present disclosure, such as the transitional phrases “including,” “comprising,” “having,” “containing,” or “involving,” and variations thereof, is intended to be broad and encompass a composition, a group of elements, a process or method steps, or any other expression listed thereafter, as well as equivalents, and additional subject matter not recited. Further, the transitional phrases “comprising,” “including,” or “containing,” are intended to encompass narrow language, such as the transitional phrases “consisting essentially of,” “consisting, of,” or “selected from the group of consisting of,” preceding the recitation of the composition, the group of elements, the process or the method steps or any other expression.

It is intended that the corresponding structures, materials, acts, and equivalents of all means or step plus function elements in the claims include any structure, material, or act for performing the function in combination with other claimed elements as specifically claimed. The disclosed embodiments are presented for purposes of illustration and description, but are not intended to limit the invention. Modifications and variations of the disclosed embodiments will be apparent to those of ordinary skill in the art without departing from the scope and spirit of the invention. Accordingly, while the invention has been described in terms of embodiments, those of skill in the art will recognize that the invention can be practiced with modifications and in the spirit and scope of the claims.

The disclosed embodiments relate to modular well testing systems, and methods therefor. More specifically, the embodiments are directed to a well testing system adapted to be modular, compact, mobile, and/or flexible in its assembly and arrangement. According to aspects of the invention, the disclosed surface well testing system reduces rig space, installation time, de-installation time, equipment volume and access and difficulty of moving heavy equipment and piping. Further, aspects of the disclosed embodiments decrease the risk of injury of the personnel involved in this activity. For example, embodiments of the disclosed well testing system have a maximum deck load of about two (2.0) tons per square meter. In addition, embodiments of the disclosed well testing system take about 14 meters by 6.5 meters of deck area having a unique or distributed arrangement. Further, the disclosed well testing system can be rigged up by about three people in about three days, whereas conventional systems can requires about ten people and about ten days.

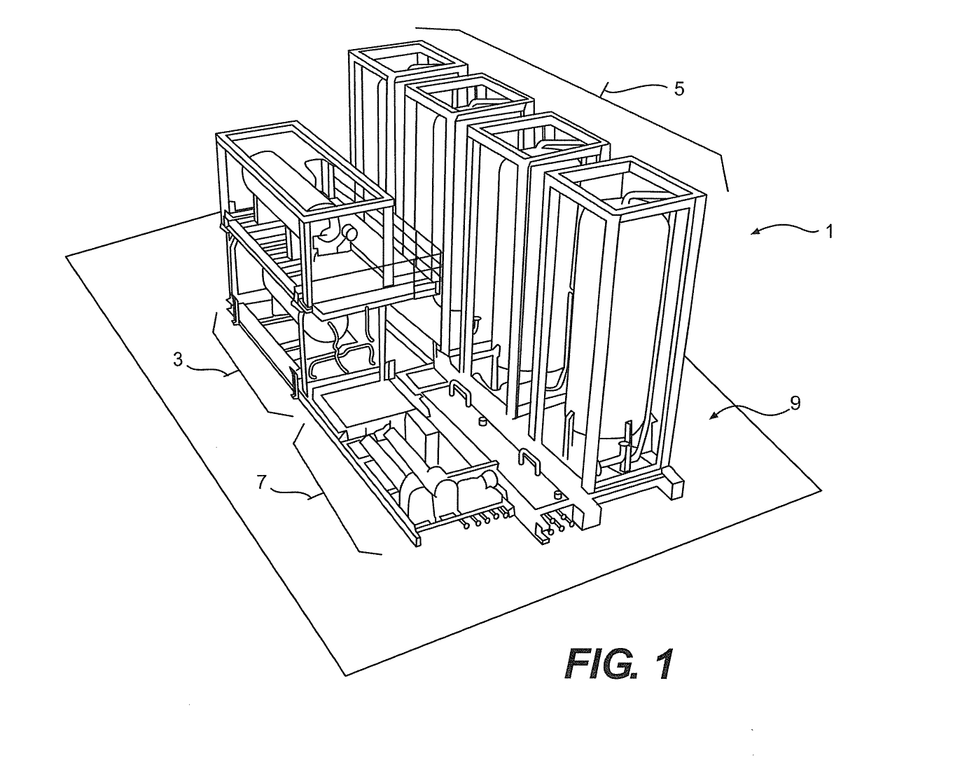

FIG. 1 shows a modular well testing system 1 in accordance with embodiments disclosed herein. The well testing system 1 includes a separator-exchanger module 3, a fluid storage module 5, and a flow-control module 7. In one embodiment, the fluid storage is a surge tank and the flow-control is a manifold. In embodiments, one or more of the modules 3, 5 and 7 are interconnected using various guiding, stopping, and fixing clamps. The well testing system can be securely attached to a deck 9 of, for example, a drilling rig in a configuration having a compact and unique arrangement.

### The Separator-Exchanger Module

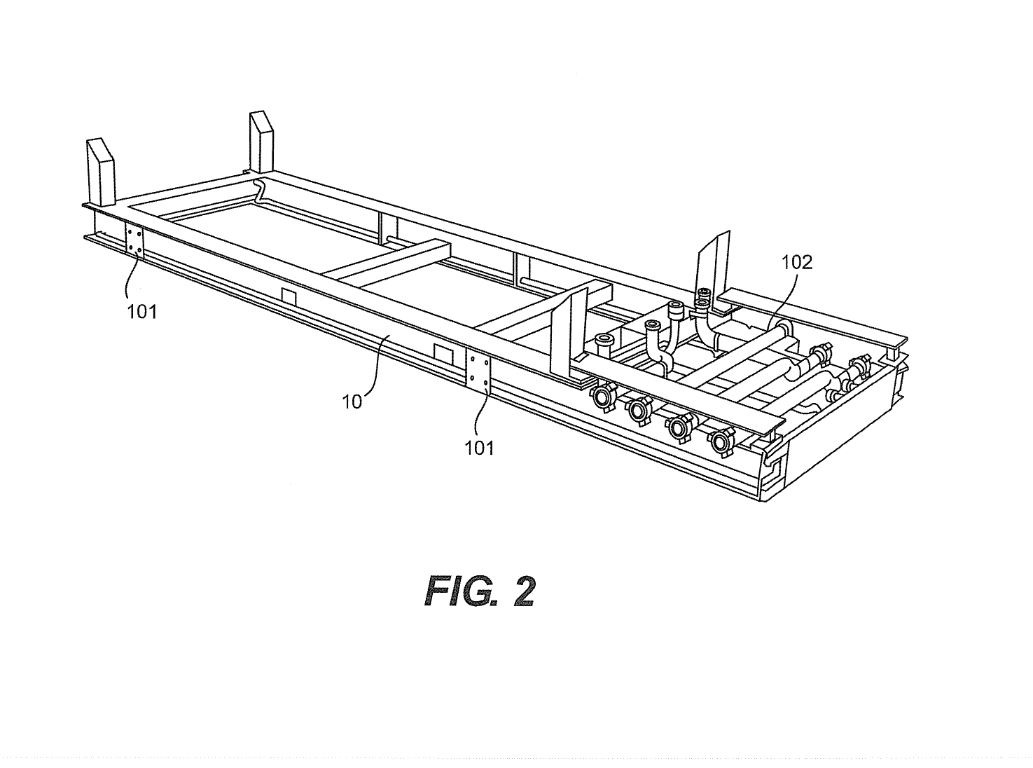

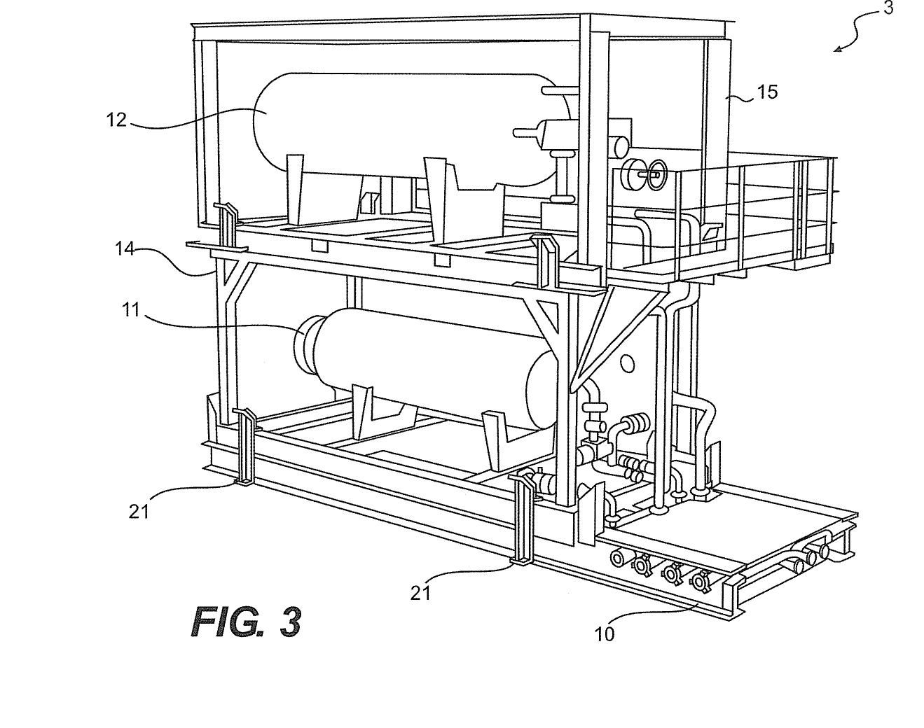

In embodiments, the separator-exchanger module 3 includes a separator frame, a separator and/or a steam-heat exchanger. FIG. 2 shows a separator frame 10 in accordance with embodiments disclosed herein. The separator frame 10 is a unit adapted to support the weight of heavy equipment. In embodiments, the separator frame 10 is comprised of structural beams sufficient to bear the weight of the separator 11 and the steam-heat exchanger 12 (FIG. 3), one stacked above the other. The separator frame equipment may be certified according to a DNV lifting certification (DNV 2.7-3 Type 2 Certified).

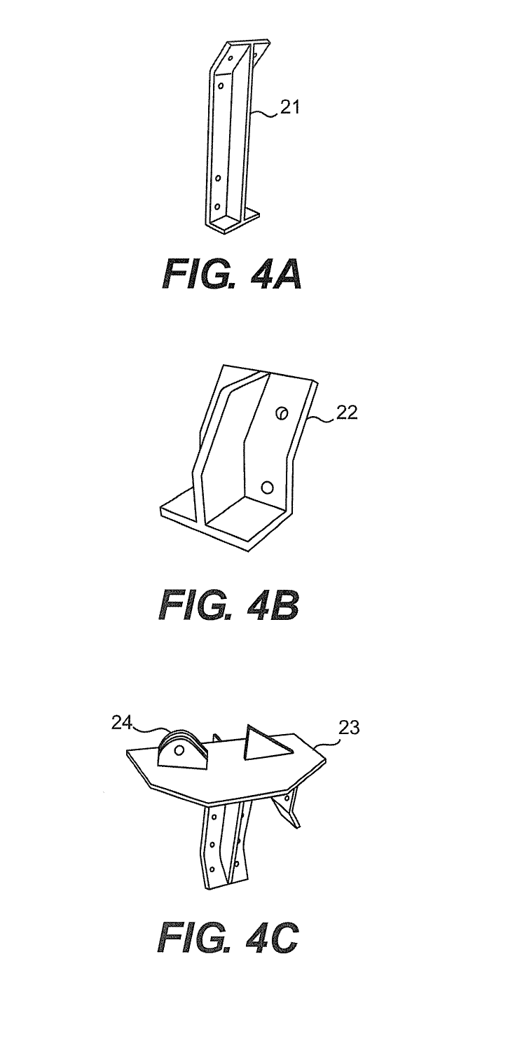

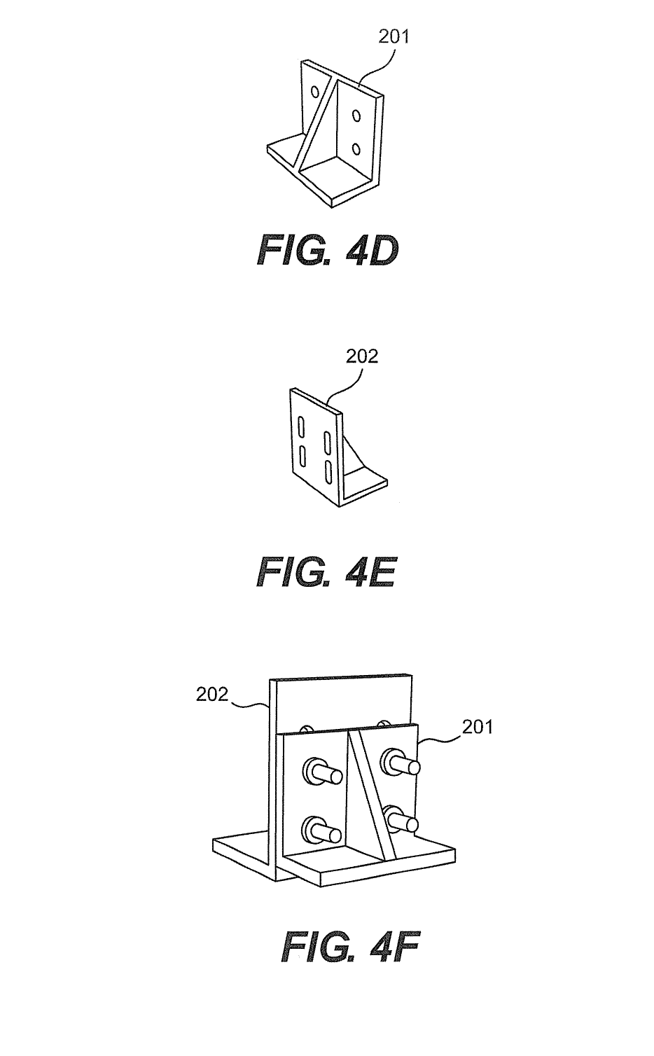

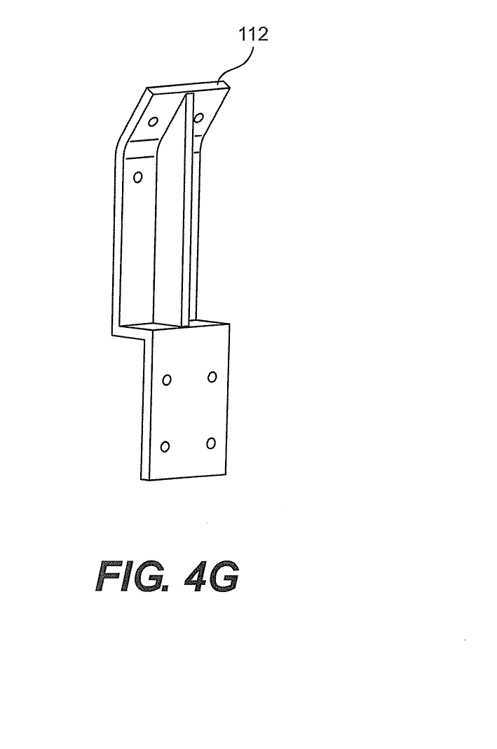

According to aspects of the disclosed embodiments, the structural beams of the separator frame 10 have pre-fabricated locations 101 for attaching guiding and stopping clamps (FIG. 4A). The separator frame 10 also includes pipes 102 and/or portions thereof, which can connect the frame to other modules of the well test system 1, including the separator 11, and the manifold module 7. In embodiments, the separator frame 10 includes at least five pipes for supplying fluids in or out of the separator 11 after assembly of the well test system. The pipes 102 can be marked to indicate the fluid to be passed through them. The pipes 102 are also positioned securely on the separator frame 10 to enable connection with the corresponding pipes of, for example, the separator 11 and the manifold module 7. By prefabricating the separator frame 10 with pipes 102, the time and effort required to assemble the well testing system is reduced in comparison to conventional systems. For example, prefabricated spools having specific dimensions can be easily connected with the pipes 102 by doing this the risk of an effluent leak is reduced due to the decrease of the number of connections that can fail.

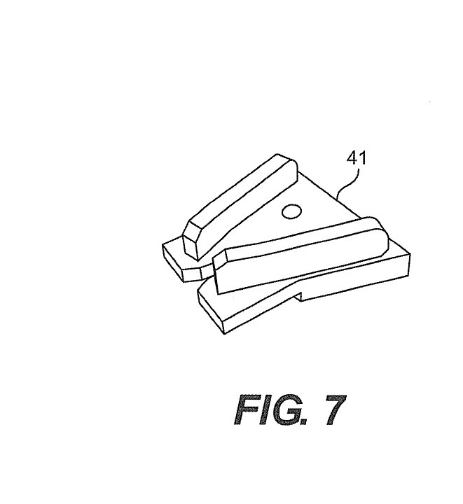

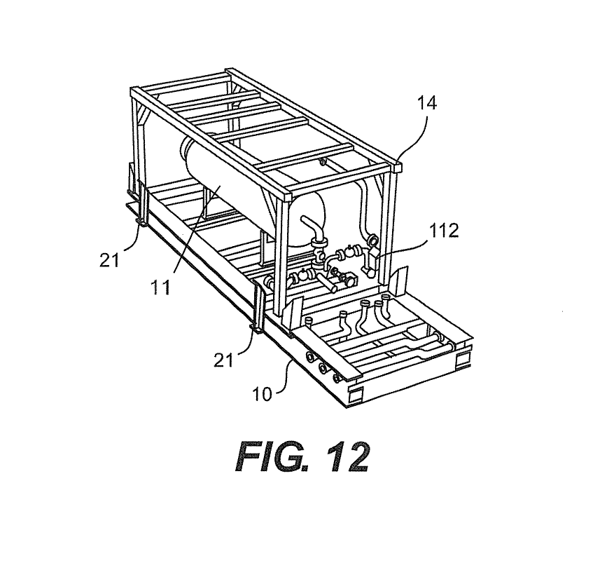

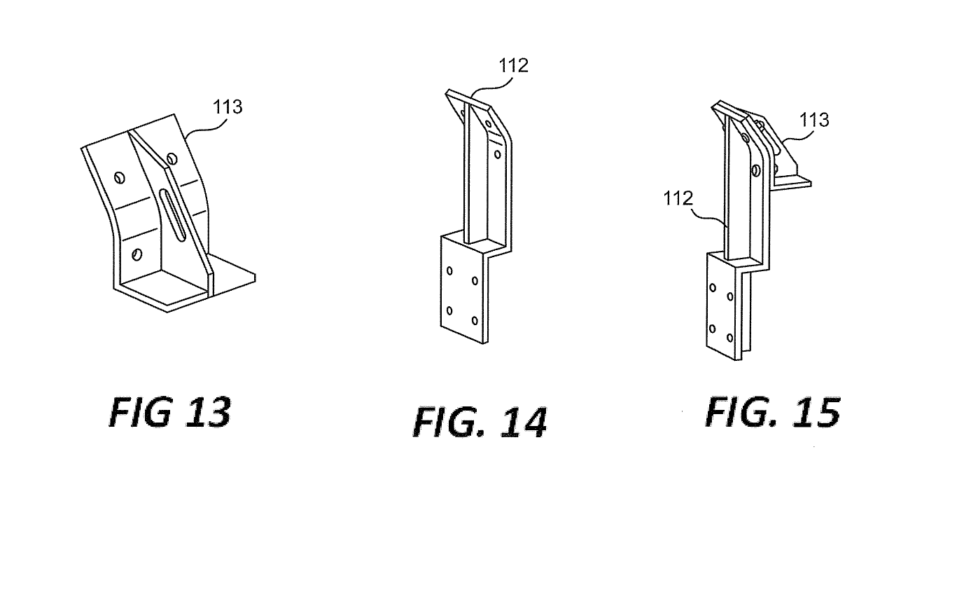

FIG. 3 shows the separator 11 and the steam-heat exchanger 12 mounted on the separator frame 10 in accordance with embodiments disclosed herein. The illustrated assembly also depicts corresponding access system stairs, walkways and handrails. As described above with respect to the modular separator frame 10 shown in FIG. 2, the separator 11 and the steam-heat exchanger 12 (shown in FIG. 7) are modules configured to stack on top of the separator frame 10. More specifically, the separator 11 and the steam-heat exchanger 12 are surrounded by respective structural frames 14 and 15 that support these elements in the well test system 1 and allow them to be easily picked-up, moved, and stacked, as additionally described with respect to FIGS. 12 and 13.

The separator 11 separates the well effluent into three main fluids (gas, oil, and water) and solids to enable these fluids to be individually measured and directed for collection, burning/flaring, or controlled disposal, depending on a particular test application. The steam-heat exchanger 12 is used to raise the temperature of well effluents to prevent hydrate formation, reduce viscosity, break down emulsions for efficient separation of oil and water and also increase the burning efficiency.

The separator 11 and steam-heat exchanger 12 can be mounted in a stacked arrangement on the modular separator frame 10, as illustrated in FIG. 3, which shows the separator 11 and the steam-heat exchanger 12 assembled into the separator-exchanger module 3. After assembly (e.g., on a rig), a mechanism is provided to avoid the well testing system 1 from sliding and twisting due to movements of a deck (e.g., deck 9). By stacking the separator 11 and the steam-heat exchanger 12, the amount of area on the surface of a drill rig is reduced in comparison to conventional systems. While FIG. 3 illustrates the steam-heat exchanger 12 stacked on top of the separator 11, these structures are modular, and, as such, it is contemplated in some embodiments stacking the separator on top of the steam-heat exchanger 12.

FIG. 4A shows a guiding and stopping clamp 21 in accordance with embodiments disclosed herein. These clamps have the function of guiding the modules (including, e.g., the separator 11 and the steam-heat exchanger 12) at the time of assembly, and precisely stopping the modules at particular positions of the well testing system 1. Further, the use of these clamps to precisely position the modules and their components enables the usage of pre-manufactured spools with specific dimensions (e.g., the dimensions of prefabricated spools) that align with piping (e.g., pipes 102) in the modules. As such, the time and labor used to interconnect the well test system 1 is reduced.

In embodiments, the guiding and stopping clamp 21 positions the separator 11 on the separator structure frame 10. Additionally or alternatively, the guiding and stopping clamp 21 can be attached to the modular separator frame 10 at predetermined locations, such as locations 101 depicted in FIG. 2, to prevent twisting of the assembled well testing system 1 due to movements of a rig (e.g., to wind and/or waves). (FIG. 3.) FIG. 4B shows the fixing clamp 22, in accordance with embodiments disclosed herein. In embodiments, the fixing clamp 22 prevents twisting of the separator-exchanger module 3.

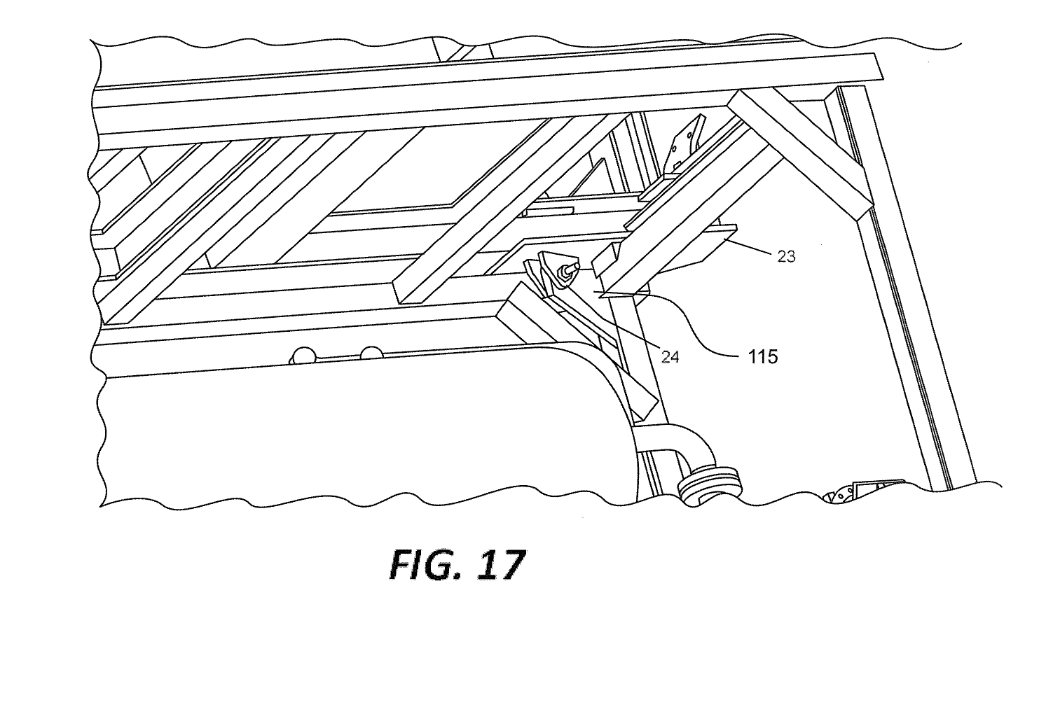

FIG. 4C shows the guiding and stopping clamp 21 and the fixing clamp 22 connected to a top guiding clamp 23, in accordance with embodiments disclosed herein. The guiding and stopping clamp 21, the fixing clamp 22 can be connected to the top guiding clamp 23 using conventional methods (e.g., welding, bolting, riveting). In accordance with aspects of the invention, the top guiding clamp 23 attaches the stopping clamp 21 and the fixing claim 22 to the top of the separator 11 and is used to place the steam-heat exchanger 12 in alignment with the separator module 11. In embodiments, the top guiding clamp 23 includes an eye hole 24 on its lower surface through which the top guiding clamp can be securely pinned to a pad eye of a separator frame. (FIG. 17.)

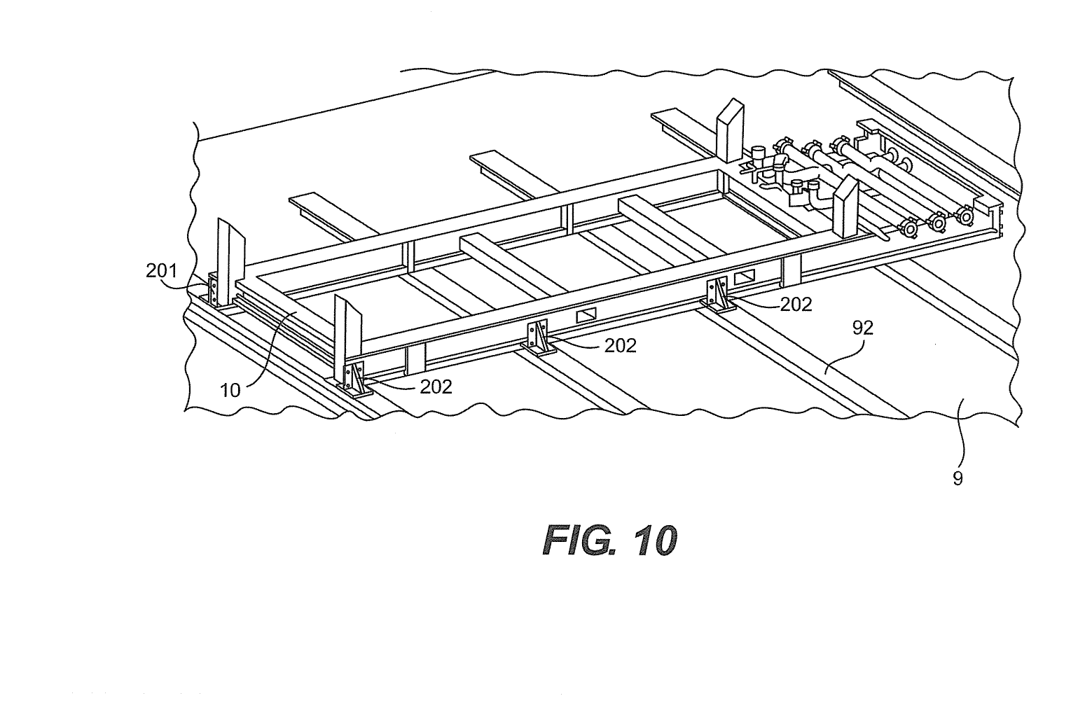

FIGS. 4D to 4F show exemplary clamps configured to be connected to the deck of a rig. (FIG. 10.) In embodiments, the clamp 201 is connected (e.g., by welding, bolting or riveting) to a deck (e.g., deck 9). For instance, a number of clamps 201 can be attached to hard points on a rig's deck. A clamp 202 grips a flange of a frame (e.g., separator frame 10) after tightly securing clamp 201 on clamp 202, e.g., using bolts, as shown in FIG. 4F.

FIG. 4G shows a guiding clamp 112. In embodiments, the guiding clamp 112 positions the separator 11 on the separator structure frame 10. Additionally or alternatively, the guiding clamp 112 can be attached to the modular separator frame 10 at predetermined locations, such as locations 101 in FIG. 2, to prevent twisting of the to prevent twisting of the assembled well testing system 1 due to movements of a rig (e.g., to wind and/or waves).

### The Surge Tank Module

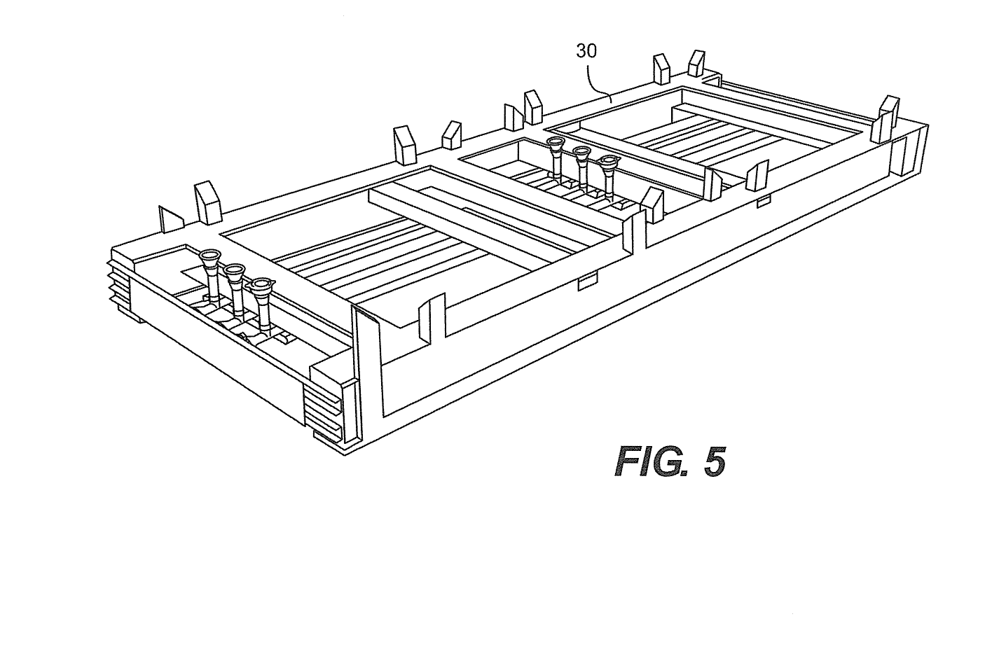

According to aspects of the disclosed embodiments, the surge tank module 5 can include a surge tank frame and a surge tank front frame and vertical surge tanks. FIG. 5 shows an exemplary surge tank frame 30 that can be used in the surge tank module 5. In embodiments, the surge tank frame 30 is comprised of structural beams having sufficient strength to support at least two surge tanks and their contents. Similar to the separator frame 10, the structural beams of the surge tank frame 30 can have pre-fabricated locations for affixing guiding and stopping clamps 21 and fixing clamps 22 to guide vertical surge tanks to predetermined positions on the surge tank frame 30, such that they are aligned at the positions and fixed securely in place. The surge tank frame 30 is configured to support the weight of two vertical surge tanks and distribute the weight over an area of the deck 9. Further, as shown in FIG. 5, the surge tank frame 30 can include pre-installed pipework providing fluid connections between to the surge tank module 5 and other modules of the well testing system 1, including the separator-exchanger module 3 and/or the manifold module 7.

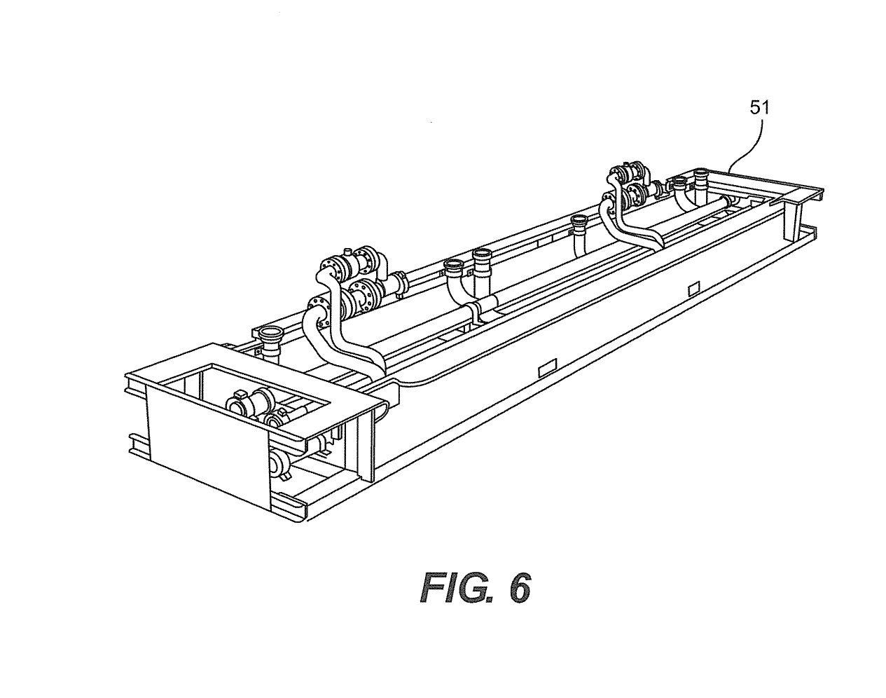

FIG. 6 shows a surge tank front frame 51 in accordance with embodiments disclosed herein. The surge tank front frame 51 can be used as part of the pipework that is conventionally installed after assembly of a rig. The surge tank front frame 51 may be comprised of structural beams. The surge tank front frame 51 can be attached to the surge tank frame 30 shown in FIG. 5 to spread the weight of the surge tanks, thereby decreasing the load placed on the deck of a rig (e.g., deck 9). The equipment may include a DNV lifting certification (e.g., a DNV 2.7-3 Type 2 certification). Further, as shown in FIG. 6, the surge tank front frame 51 can include pre-installed pipework providing fluid connections between the surge tank module 5 and other modules of the well testing system 1, including the separator-exchanger module 3 and/or the manifold module 7.

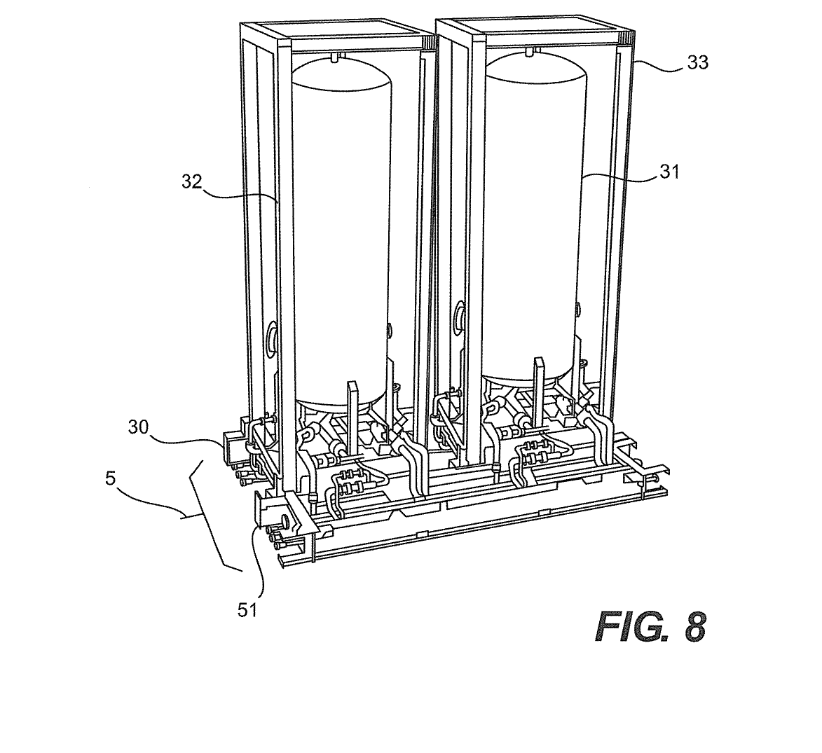

FIG. 7 shows a surge tank clamp 41 in accordance with aspects of the disclosed embodiments. The surge tank clamp 41 can be used in the surge tank module 5 to guide and securely attach the surge tank frame structure 33 to the surge tank frame 30. (FIG. 8.) The surge tank clamp 41 prevents the surge tanks and/or their respective frames from twisting due, for example, to movement of the deck 9. Further, one or more of the fixing clamps 22 can be securely attached to the surge tank frame 30 and to the frame structure 33 to prevent the surge tanks from moving and/or twisting due to, for example, movement of a rig. The equipment may include a DNV lifting certification (DNV 2.7-3 Type 2 Certified).

In accordance with embodiments disclosed herein, FIG. 8 shows exemplary surge tanks 31 and 32 mounted on the surge tank frame 30 to be used in the surge tank module 5. The surge tanks 31 and 32 are used to store liquids produced during well testing, for example, prior to disposal. Additionally or alternatively, the surge tanks 31 and 32 are used as an additional stage of separation and metering.

FIG. 8 shows an exemplary surge tank module 5 in accordance with embodiments disclosed herein. In embodiments, the surge tank module 5 is composed of the surge tank frame 30, the vertical surge tanks 31 and 32, and the surge tank front frame 51. These elements can be connected to each other with, for example, screws or some other attachment mechanism. In embodiments, each of vertical surge tanks 31, 32 is securely positioned inside a frame structure 33, as shown in FIG. 8 that supports these elements in the well test system 1 and allows them to be easily picked-up, moved, and stacked. The modular surge tanks 31, 32 with their frame 33 can be positioned using a lifting device on top of the modular surge tank frame 30.

Although a single surge tank module 5 is shown in FIG. 8, it is contemplated that the well testing system 1 can include one or more additional surge tank modules 5 by securely attaching one beside the other on, for example, the deck 9, as shown in FIG. 1. Therefore, the well testing system 1 may readily accommodate more than two surge tanks by easily adding additional surge tank modules to allow for 4 or more surge tanks to handle the fluid disposal needs of the well test design. The modular and compact configuration of the surge tank module 5 (together with the manifold module 3) can be readily be adjusted to accommodate different effluent flow rates, and thereby offers flexibility for the compact well system enabling to successfully serve the well test design needs of different wells.

### The Manifold Module

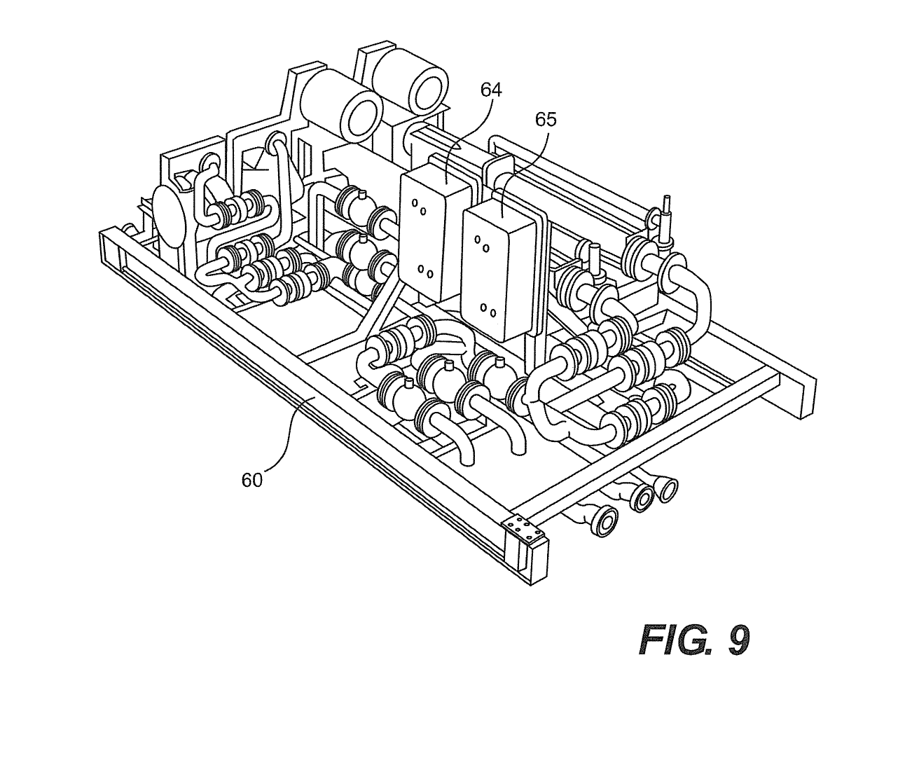

In accordance with embodiments disclosed herein, the manifold module 7 includes a compact manifold. FIG. 9 shows an exemplary compact manifold 60. The compact manifold 60 is an arrangement of piping, valves and oil and water pumps configured to control, distribute and monitor fluid flow in the well testing system 1. The compact manifold 60 combines many of the functionalities of between 6 to 10 pieces of conventional equipment.

As shown in FIG. 9, the compact manifold 60 can include pre-installed pipework providing fluid connections between the manifold module 7, the separator-exchanger module 3 and/or the surge tank module 5. In embodiments, the compact manifold 60 includes four pumping units being two air driven pumps and two electrical pumps with their respective control panels 64 and 65. The compact manifold 60 includes a plurality of pipes providing one or more pathways to transfer the well effluent to the separator 11. Additionally or alternatively, embodiments of the compact manifold 60 direct fluids to various equipment and flow lines, and to circulate the fluid between tanks 31 and 32. (FIG. 22.) For example, one or more fluid pathways can include valve mechanisms for controlling the flow of the effluent before it reaches the separator 11. The compact manifold 60 can include a DNV lifting certification (DNV 2.7-1 Certified).

### Process Steps

In reference to the foregoing, the assembly and installation of the compact well system will be explained.

In accordance with aspects of the present invention, the separator-exchanger module 3 is rigged up in the sequence described below. As shown in FIG. 10, the modular separator frame 10 is placed at a desired position at the deck 9. The separator frame 10 can be securely fixed to the deck 9 (e.g., at hard points 92) using brackets 201 and 202 detailed, for example, in FIGS. 4D and 4E.

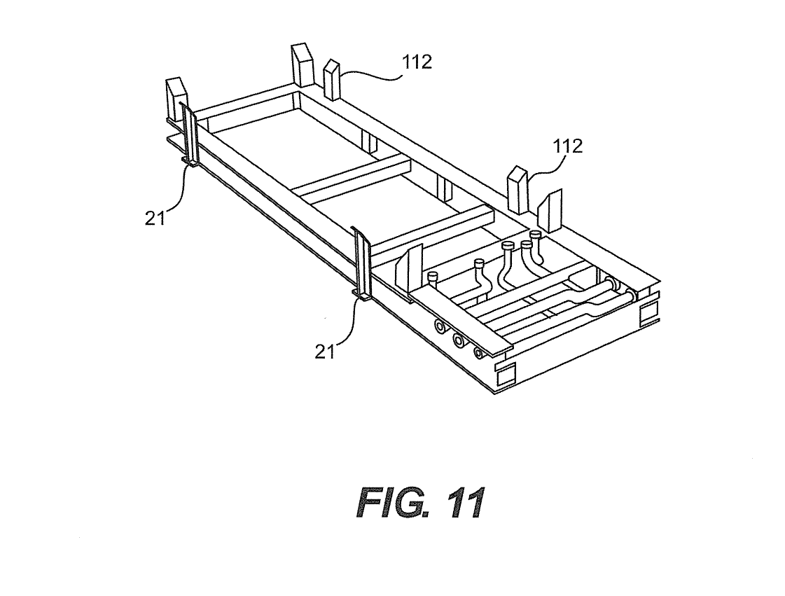

As shown in FIG. 11, before positioning the separator 11 on top of the separator frame 10, the guiding clamps 21 and/or 112 are attached to the side of the separator frame 10 using fastening mechanism, such as screws. The guiding clamps 21 and/or 112 are positioned at the pre-fabricated locations 101 found on the structural beams comprising the separator frame 10. In embodiments, the two different types of guiding clamps 21 and 112 can be used, one for each side.

As shown in FIG. 12, the separator 11 is mounted securely inside a structural frame 14 that allows lifting the separator 11. The structural frame 14 is then placed into an aligned position on the separator frame 10, as guided by the guiding clamps 21 and/or 112. As shown in FIGS. 13-15, the separator top clamp 113 can be screwed on clamp 112. Likewise, the top clamp can also be screwed on clamp 21

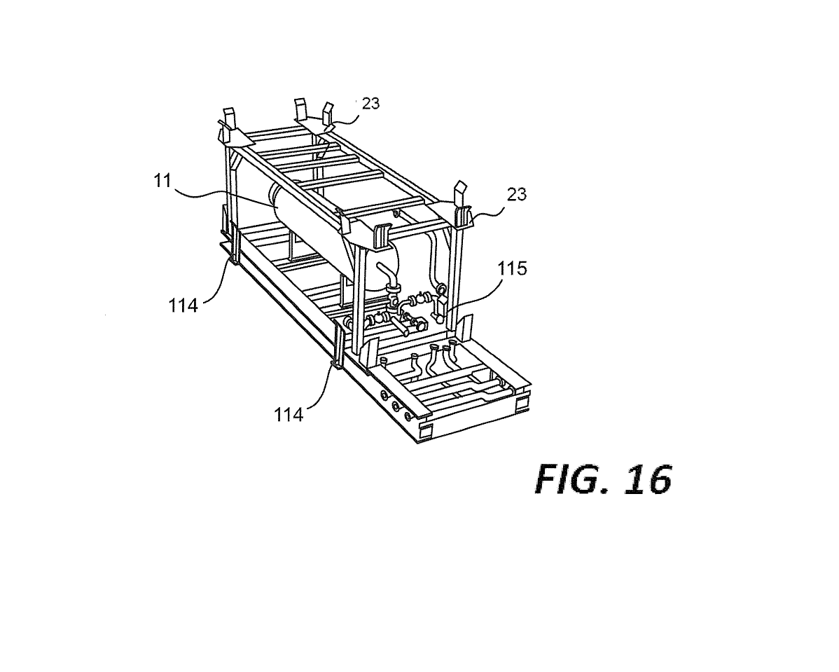

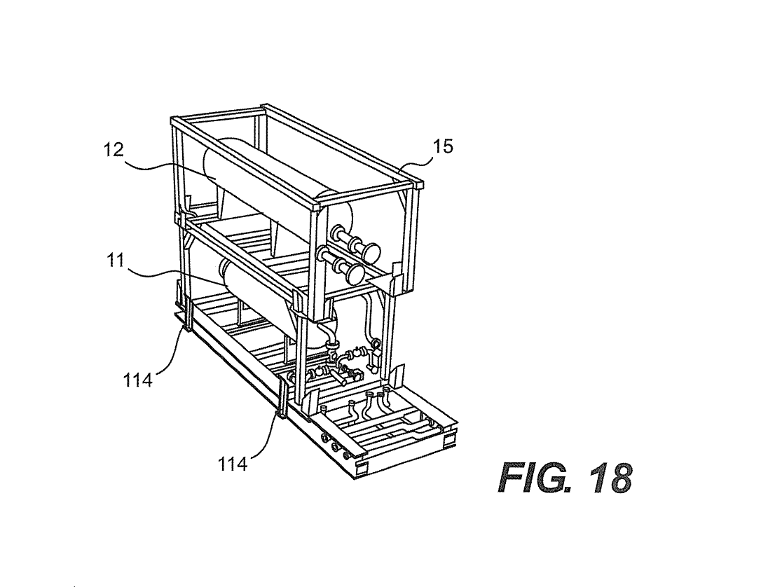

As shown in FIGS. 16 and 17, a number of the separator top guiding clamps 23 are attached to pad eyes 115 of the structural frame 14 of the separator 11 using respective eye holes 24. As shown in FIG. 18, the steam-heat exchanger 12 may be placed above the separator in an exact position using the top guiding clamps 23. The steam-heat exchanger 12 is also positioned inside a structural frame 15 to allow it to be lifted and positioned on top of the structural frame 14 of the separator 11.

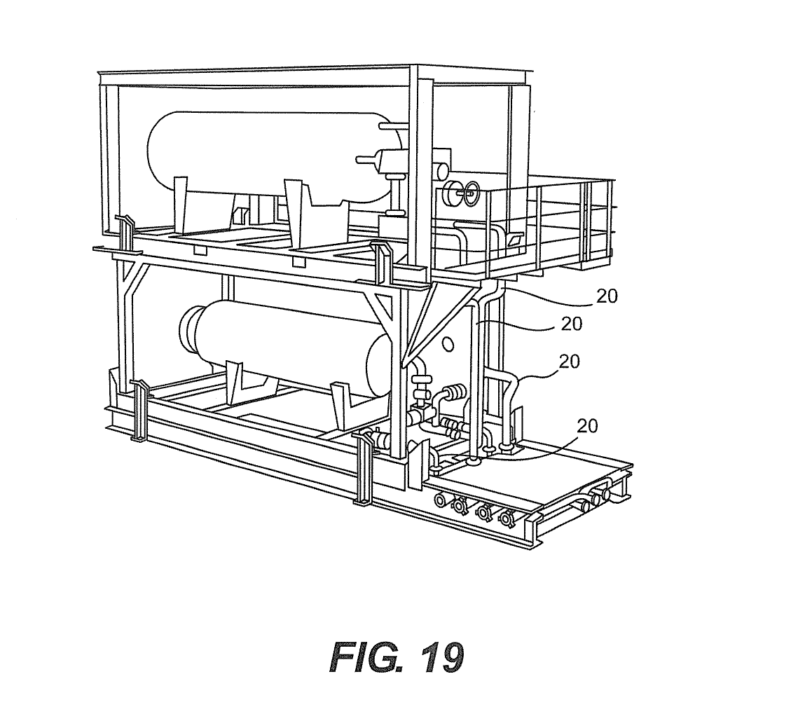

As shown in FIG. 19, after assembling the separator-exchanger module 3, intermediate spools 20 can be used to operably connect the pipes of the equipment to each other. The intermediate spools 20 have fixed dimensions to match the connection points of the pipes of the separator and/or the exchanger modules, which can allow as few as two connections to be tightened.

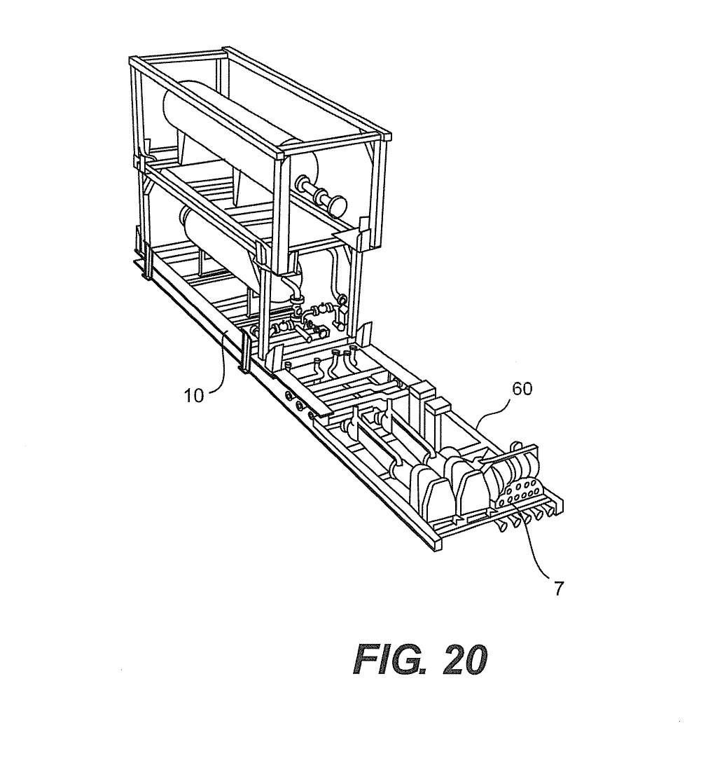

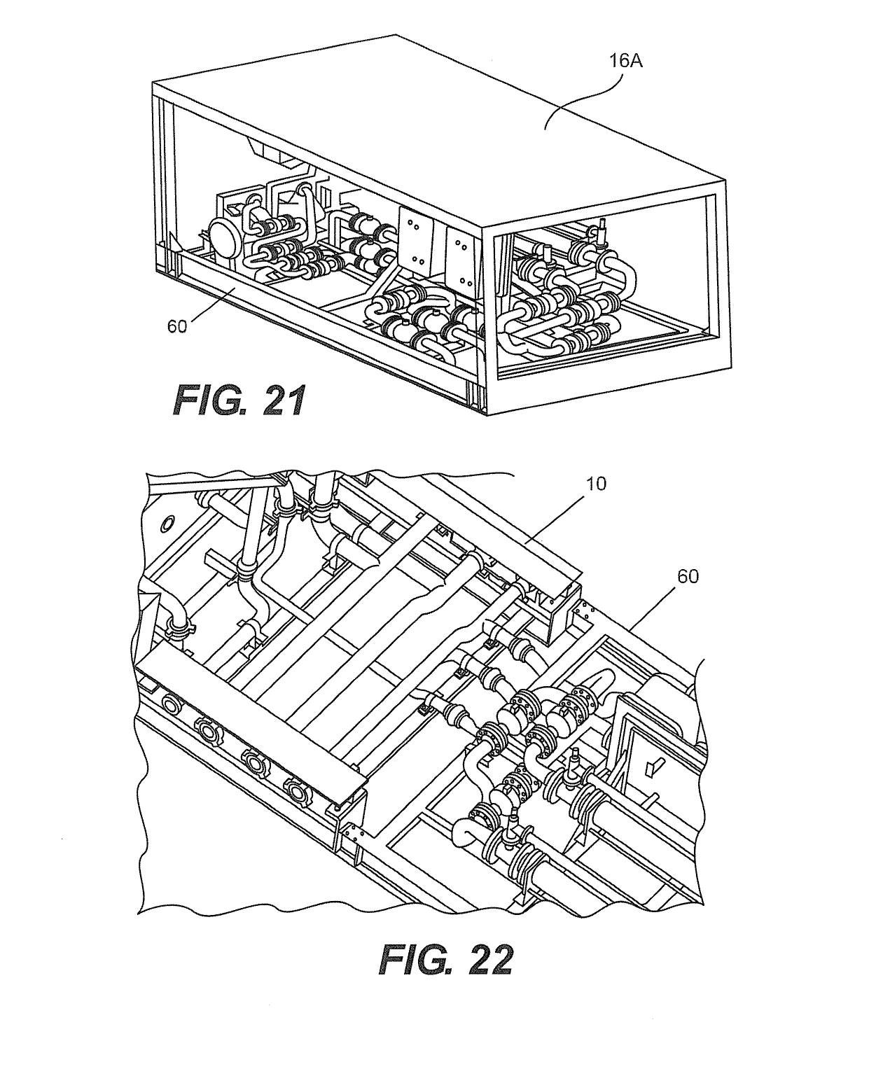

FIG. 20 shows the connection of the manifold module 7 to the well testing system 1. More specifically, the compact manifold 60 can be directly connected to the modular separator frame 10. According to embodiments, as shown in FIG. 21, the compact manifold 60 can be provided with a top frame 16A, which allows it to be lifted and placed on the deck 9. As shown in FIG. 22, the top frame 16A can be removed once the compact manifold 60 is placed on the desired position on the deck 9.

Referring back to FIG. 1, the figure shows the connection of the surge tank module 5. According to one embodiment, at least four surge tanks are used in the compact well testing system

In well testing systems, pipework is rigged up in order to interconnect the inlet and outlets of the surge tanks. Operating the tank valves and taking level measurements exposes the human operators to the risk of walking through such pipework. Also the rig up time for such pipework is an issue due to the difficulty of finding the right position for each pipe. However, according to aspects of the disclosed embodiments, the two frames spread the weight of the surge tanks, carry the pipe already rigged up from the base, and keep the piping under the operator level, making the working environment safer. There is a grating where the operator can walk. Below the grating there are all the pre-installed hydraulic piping and connections.

In the same way, the hydraulic pipes are ready to be inter-connected within the supporting frames, they are frames with pre-wiring for power supply distribution (electrical cables and compressed air) and data acquisition (cables for the sensors).

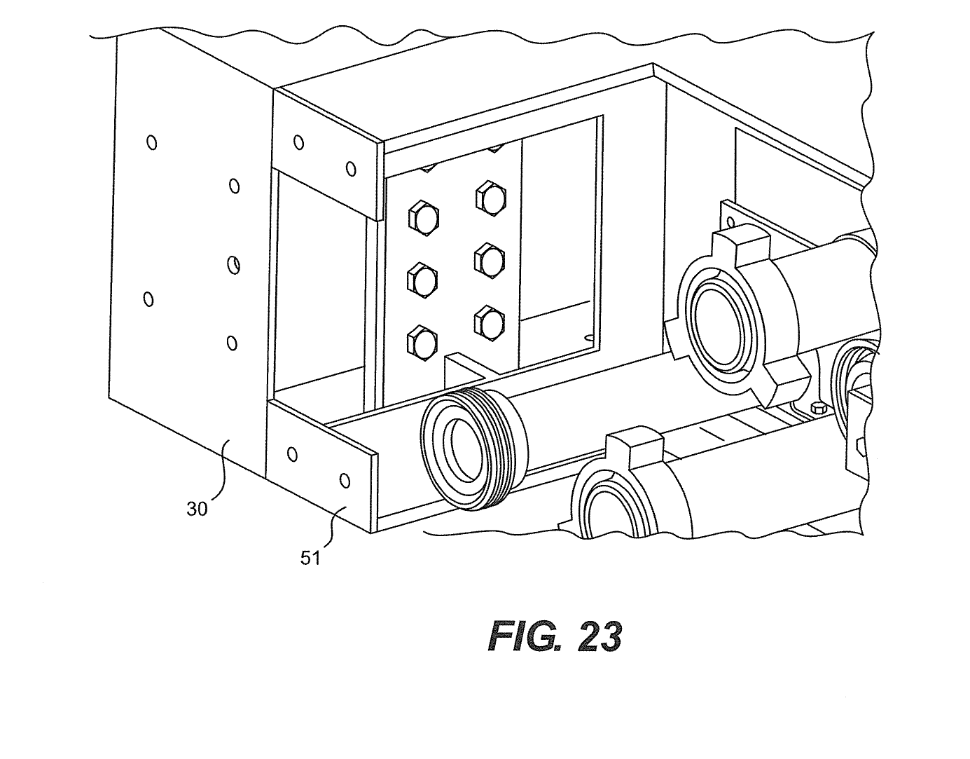

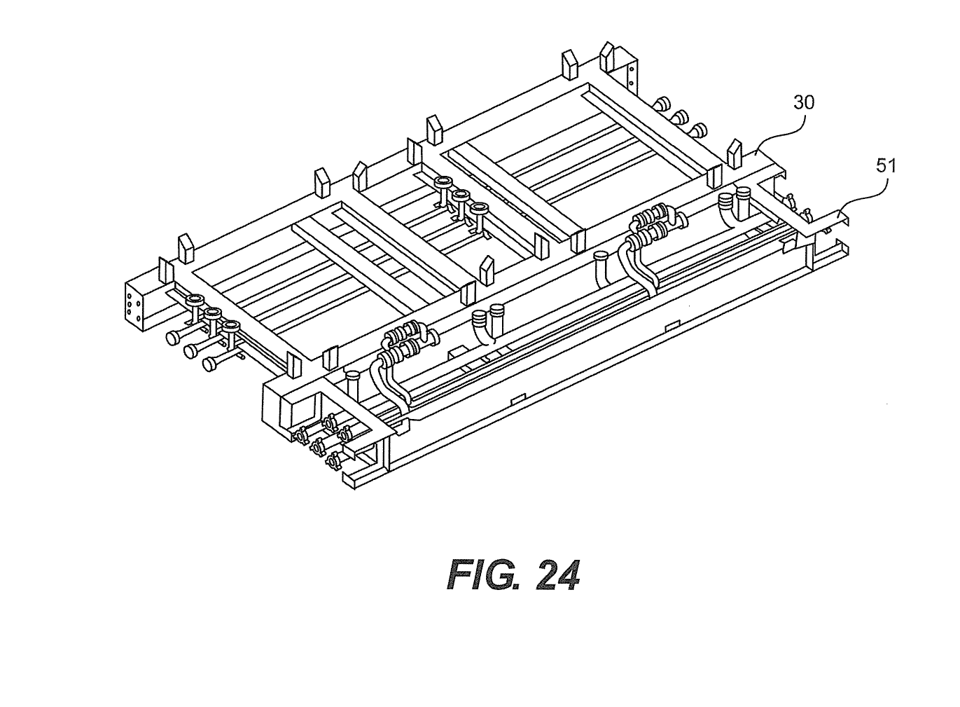

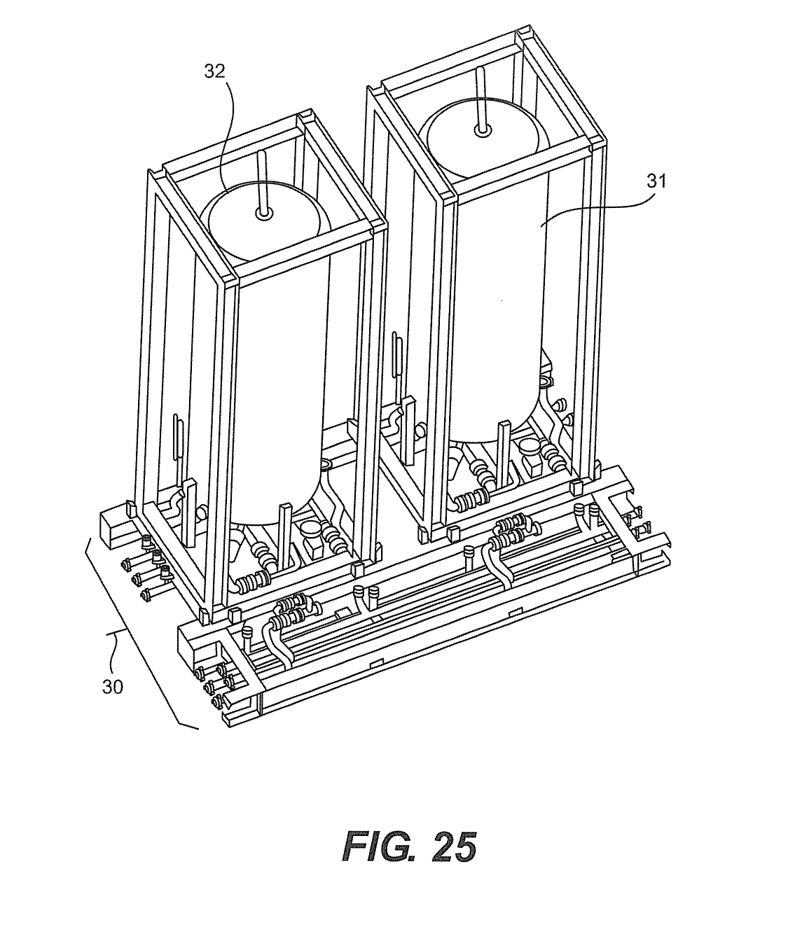

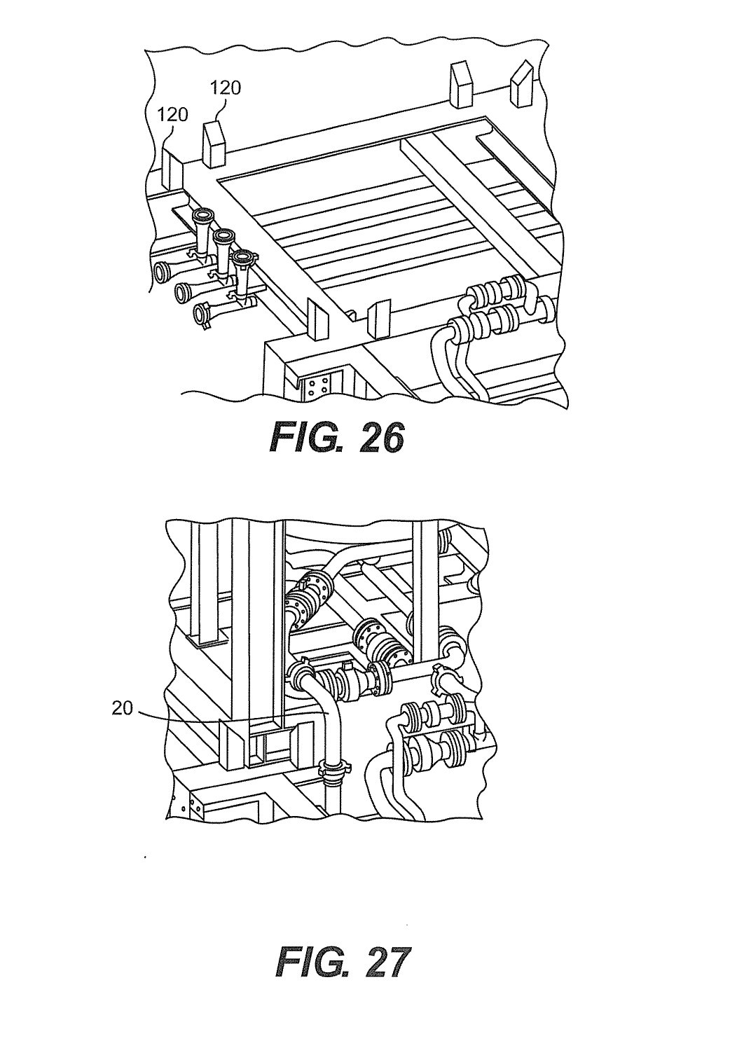

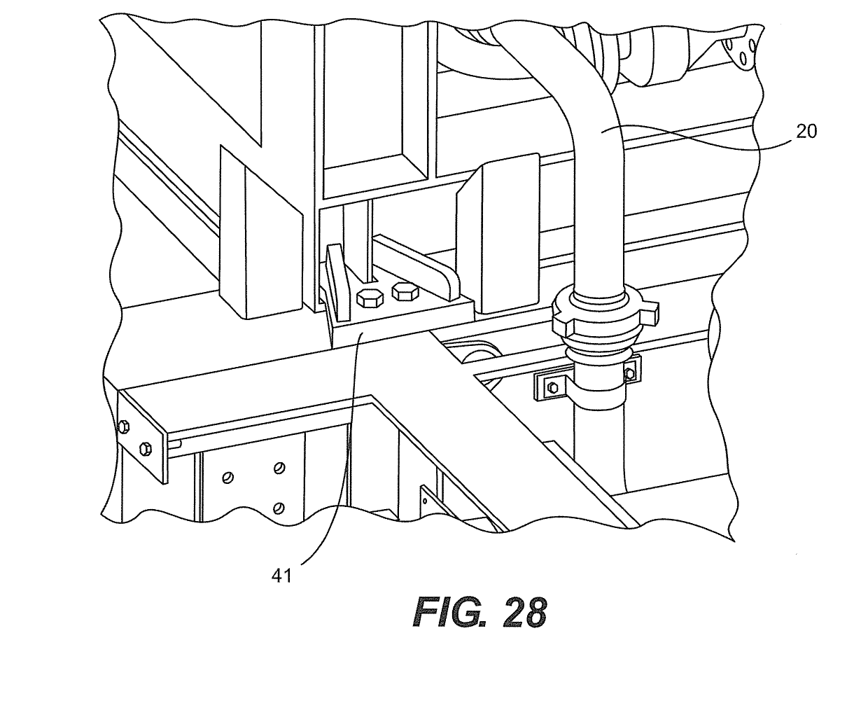

As shown in FIG. 23, the surge tank frame 30 and the surge tank front frame 51 are positioned on the deck 9 next to each other and are securely attached together with screws. As shown in FIG. 24, the surge tank frame 30 and the surge tank front frame 51 are connected to each other. As shown in FIG. 25, the surge tanks 31 and 32 are placed above the surge tank frame 30. As shown in FIG. 26, the positions of the surge tanks 31 and 32 are defined by stoppers 120. As shown in FIG. 27, after placing the surge tanks 31 and 32, the intermediate spools 20 are connected to the surge tanks. As shown in FIG. 28, the surge tank clamp 41 is attached to the frame 33, to prevent the surge tanks 31 and 32 from twisting. To connect the tank frames and the compact manifold, standard pipework is used.

Although only a few exemplary embodiments have been described in detail above, those skilled in the art will readily appreciate that many modifications are possible in the exemplary embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ or ‘steps for’ together with an associated function.

What is claimed is:

1. A well testing system comprising:
a first module comprising a separator frame configured to receive a separator and/or a steam-heat exchanger;
a second module comprising a fluid storage frame and a fluid storage front frame, wherein the fluid storage frame is configured to receive at least two fluid storages;
a third module comprising a compact flow-control; and
at least one element selected from the group consisting of the separator frame, the separator, the steam-heat exchanger, the fluid storage frame, and the at least two fluid storage interconnects with another element of the group through one or more clamps.

2. The well testing system of claim 1, wherein the flow-control is a manifold and the fluid storage is a surge tank.

3. The well testing system of claim 1, wherein the modular separator frame includes pipes for fluid connection between the first module and the second module, or between the first module and the third module.

4. The well testing system of claim 2, wherein the surge tank frame or the surge tank front frame includes pipes for fluid connection between the second module and the first module, or between the second module and the third module.

5. The well testing system of claim 2, wherein the compact manifold includes pipes for fluid connection between the third module and the first module, or between the third module and the second module.

6. The well testing system of claim 1, wherein the separator and the separator frame interconnect through the one or more clamps.

7. The well testing system of claim 6, wherein the one or more clamps are configured to align the separator with the steam-heat exchanger.

8. The well testing system of claim 6, wherein:
the steam-heat exchanger is positioned above the separator; and
the separator frame interconnects to a steam-heat exchanger frame through the one or more clamps.

9. The well testing system of claim 6, wherein the separator is positioned above the steam-heat exchanger.

10. The well testing system of claim 8, wherein the one or more clamps align and secure the steam-heat exchanger with the separator frame.

11. The well testing system of claim 2, wherein the surge tank frame interconnects to the surge tank through the one or more clamps.

12. The well testing system of claim 11, wherein the one or more clamps are configured to align and secure the surge tank with a structural frame.

13. The well testing system of claim 1, further comprising another second module.

14. The well testing system of claim 1, further comprising two more second modules.

15. A method of constructing a well testing system comprising:
placing a separator frame on a deck;
placing a first guiding, stopping and/or fixing clamp on the separator frame;
placing a separator on the separator frame using the first guiding, stopping and fixing clamp;
placing a modular surge tank frame on the deck;
placing a modular surge tank front frame on the deck;
assembling the modular surge tank frame and the modular surge tank front frame to obtain a surge tank frame;
placing a second guiding, stopping and/or fixing clamps on the surge tank frame;
placing two surge tanks on the surge tank frame using the second guiding, stopping and/or fixing clamps;
placing a compact manifold on the deck; and
interconnecting the separator frame with the surge tank frame and the compact manifold.

16. The method of claim 15, further comprising:
placing a third guiding, stopping and/or fixing clamp on the separator; and
placing a steam-heat exchanger on the separator utilizing the third guiding, stopping and/or fixing clamps.

17. The method of claim 15, wherein the separator frame includes pipes for fluid connection between a first module and a second module or between the first module and a third module.

18. The method of claim 15, wherein the surge tank frame or the surge tank front frame includes pipes for fluid connection between the second module and the first module or between the second module and the third module.

19. The method of claim 15, wherein the compact manifold includes pipes for fluid connection between the third module and the first module or the third module and the second module.

20. The method of claim 15, wherein the third guiding, stopping and/or fixing clamp aligns and secures the surge tank with the modular surge tank frame.

21. The method of claim 15, wherein the first guiding, stopping and/or fixing clamp align and secure the separator with the separator frame.

22. The method of claim 15, wherein the second guiding, stopping and/or fixing clamps aligns and secure the steam-heat exchanger in exact position relative the separator frame and the separator.

23. A method of constructing a well testing system comprising:
placing a separator frame on a deck;
placing a first guiding, stopping and/or fixing clamp on the separator frame;
placing a separator on the separator frame using the first guiding, stopping and fixing clamp;
placing a modular fluid storage frame on the deck;
placing a modular fluid storage front frame on the deck;
assembling the modular fluid storage frame and the modular fluid storage front frame to obtain a fluid storage frame;
placing a second guiding, stopping and/or fixing clamps on the fluid storage frame;
placing two fluid storages on the fluid storage frame using the second guiding, stopping and/or fixing clamps;
placing a compact flow-control on the deck; and
interconnecting the separator frame with the fluid storage frame and the compact flow-control.
